(19) United States
(12) Patent Application Publication
(10) Pub. No.: US 2008/0148706 A1
(43) Pub. Date: Jun. 26, 2008

(54) METHOD OF MAINTAINING AIRCRAFT GAS TURBINE ENGINE

(76) Inventor: Mark BEAUREGARD, Ottawa (CA)

Correspondence Address: OGILVY RENAULT LLP (PWC), 1981 MCGILL COLLEGE AVENUE, SUITE 1600, MONTREAL, QC, H3A 2Y3, omitted

(21) Appl. No.: 11/615,208

(22) Filed: Dec. 22, 2006

(51) Int. Cl. F02C 3/00; G01M 17/00

(52) U.S. Cl. 60/39.01; 701/29

(57) ABSTRACT

A method for maintaining a civil-certified aircraft engine rotating part subject to fatigue failure during service use, the method comprising the steps of providing an assembly including the rotating part and at least one other component mounted to the rotating part; determining a maximum safe operating life for the assembly; and specifying a life limit for the assembly based on the maximum safe operating life, the life limit being the maximum number of cycles the assembly may be used before replacement.

### TECHNICAL FIELD

The technical field relates generally to aircraft engines and, more particularly, to the safe maintenance of life-limited parts for civil-certified aircraft gas turbine engines.

### BACKGROUND OF THE ART

Aircraft gas turbine engines for civilian use are certified by governmental regulatory agencies such as the Federal Aviation Authority (FAA), Transport Canada (TCCA), and the European Aviation Safety Agency (EASA). A so-called Type Certificate or Type Approval is issued by the relevant regulatory authority after the gas turbine engine manufacturer demonstrates that the engine complies with the applicable regulatory design standards. Applicable design standards include FAR 33 (USA), Canadian Aviation Regulations Standard 533 and Certification Specification CS-E (EASA).

Airworthiness design standards require that special considerations be given to certain rotating components in the gas turbine engine whose failure could produce a hazard to the aircraft. These components are life-limited parts sometimes referred to as “critical” parts. Examples of critical parts are turbine, fan and compressor discs and shafts, since failure of a disc or shaft in flight can have a serious effect on the continued safe operation of the engine and aircraft.

In an attempt to reduce the probability of a critical part failing in flight, airworthiness regulations require that a maximum operating life (referred to as “life limit” herein) be specified for each critical part by the engine original equipment manufacturer (OEM). Maintenance personnel are then required to replace critical parts once the life limit of the part is achieved. The life limit is maximum service life of the part, typically defined as a maximum number of permitted cycles for the part, a cycle being an excursion from engine idle to takeoff power and back. Service lives are typically provided to the engine operators and maintenance personnel in the engine's so-called instructions for continued airworthiness (ICA)—a set of instructions or manuals which allows the engine's user to ensure the engine is maintained in an airworthy condition. A life limit, expressed as a maximum number of start-stop cycles for the critical components, is defined typically in the airworthiness limitations section of the ICA. Once this number of cycles is achieved, the component must be removed from service and replaced.

Nonetheless, there is a need for improvement in the way in which aircraft gas turbine engines for civilian use are maintained which improves the safety of such engines.

### SUMMARY

In one aspect, there is provided a method for maintaining a civil-certified aircraft engine rotating part subject to fatigue failure during service use, the method comprising the steps of: providing an assembly including the rotating part and at least one other component mounted to the rotating part; determining a maximum safe operating life for the assembly; and specifying a life limit for the assembly based on the maximum safe operating life, the life limit being the maximum number of cycles the assembly may be used before replacement.

In a second aspect, there is provided a method for providing a service programme for a life-limited part of a gas turbine engine for a civil-certified aircraft, the method comprising: identifying additional components mounted to and impacting a service life of the part, the part and additional components providing an assembly; determining a safe life limit for the assembly; requiring that the entire assembly be replaced when the life limit of the assembly is reached.

In a third aspect, there is provided a method for safely managing the replacement/servicing of a part of a rotating assembly of an aircraft gas turbine engine, the rotating assembly comprising a disc, a plurality of blades, and attachment hardware for removably fixing the blades to the disc, the method comprising: designating at least the disc and blades as a critical assembly, specifying a life limit for the assembly, and requiring replacement of the entire assembly when the life limit is achieved

Further details of these and other aspects will be apparent from the detailed description and figures included below,

### DESCRIPTION OF THE DRAWINGS

Reference is now made to the accompanying figures, in which:

FIG. 1 is a perspective view of a turbine rotor assembly of an aircraft gas turbine engine; and

FIG. 2 is a flow chart showing a process according to the present concept.

### DETAILED DESCRIPTION OF THE PREFERRED EMBODIMENTS

A Type Certificate is awarded by an aviation regulatory authority, such as the Federal Aviation Authority (FAA), to an engine manufacturer after the manufacturer has established that the particular engine model for civilian use meets or exceeds the current prevailing airworthiness requirements. Modifications to the engine may require a Supplement Type Certificate. The process of obtaining a Type Certificate or Supplement Type Certificate is often referred to as “certifying” the engine, and will be referred to as such herein.

As part of the certification process of an aircraft gas turbine engine, the applicant, typically the original equipment manufacturer (OEM) of the engine, prepares Instructions for Continued Airworthiness (ICA) which will ultimately be made available to engine operators to permit them to maintain the engine in an airworthy state. An example of an ICA is an engine maintenance manual, which sets out certain inspection and maintenance requirements for the engine. The ICAs must also, among other things, identify which parts are the “critical” or life-limited, and set forth the mandatory replacement time (i.e. the service limit) of each critical part. The term “critical part” is herein intended to refer to any engine part whose failure is likely to result in hazardous engine effects, and thus is specified as a life-limited part in the airworthiness limitations of the engine ICAs. Examples of typical critical parts are: compressor and turbine rotors/discs, and in turbofan engines, the fan rotor. For safety reasons, it is important that the identified critical parts be withdrawn from service at the approved service limit, and replaced with a new component. The life limit values are determined by testing and/or engineering analysis on the basis of a number of predictions of engine operation, material behaviour, environment etc., and are validated and approved by the relevant regulatory authority as part of the certification process.

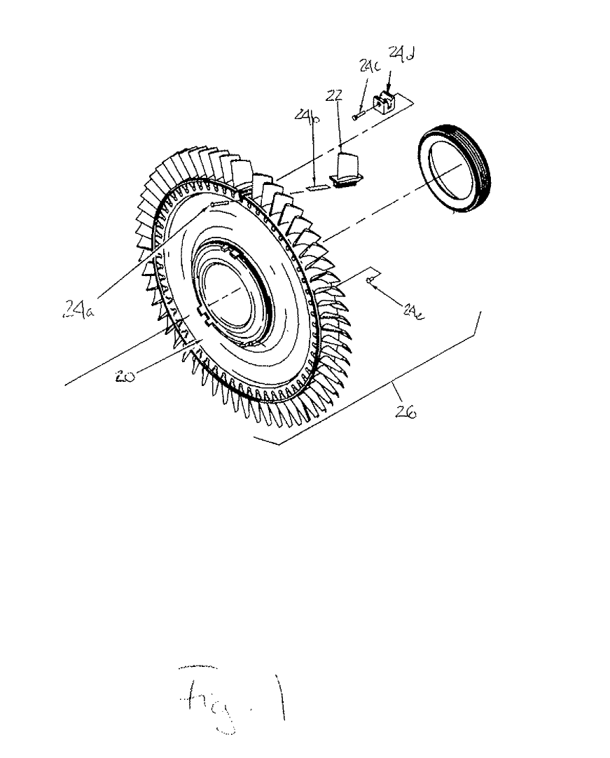

As mentioned, typically discs are considered critical or life-limited parts. However, various factors may reduce the life capability of an engine critical part and, thus, may result in a part failure before the service limit specified in the ICA. For instance, a turbine disc, such as the one shown in FIG. 1, typically consists of an assembly of multiple parts, such as a disc 20 upon which turbine blades 22 are attached using a suitable attachment hardware 24a, 24b, 24c, 24d, 24e . . . such as rivets, slots, retainers, seals, etc. Life limits are typically calculated assuming that all components of the assembly are within the OEM's original manufacturing specifications and tolerances for such components, and for the assembly. However, it has been found that if components are actually installed which do not meet these originally intended criteria, the interaction of the blades 22 with the disc 20 (in this example) can affect the low cycle fatigue (LCF) life of the disc 20. For example, if during a repair event, one or more replacement blades is mounted to the disc, a change in the blade weight relative to the originally-intended design will change the centrifugal force exerted onto the disc 20. Therefore, an increase in blade weight would normally decrease the LCF life of the disc 20, but by how much depends on several factors, and cannot easily be determined by the engine operator or maintenance personnel. The result is that the effective service life may be inadvertently reduced, relative to the life limit published in the relevant ICA, by the actions taken during the repair event.

Similarly, it has been found that if, during a repair event, the disc 20 is damaged, such as during removal and reinstallation of blades 22 which can result in undesirable nicks or scratches on the disc 20, the effective service life of the component may likewise be inadvertently reduced. If rivets are used to retain the blades 22 on the disc 20, re-riveting operations may also cause damage, or affect service life.

And yet, traditionally, only the disc 20 is defined as the “critical” part, and a life limit has been specified in gas turbine ICAs only for the disc itself. The prior art thus does not address the fact that the blades 22 and other hardware 24 influence the service life and safe life limit of the disc 20.

There is thus a need to ensure that critical rotating gas turbine parts have safe life limits which, in practice, correspond accurately to the predicted service life as set forth in the engine ICAs.

Therefore, the present approach to improving the safe use of critical life-limited parts involves providing the engine operator with rotating assemblies which are always within the original design parameters and tolerances for the assembly. In this regard, it is herein generally proposed to include all assembly parts that have a potential impact on the life of a critical rotating part in the definition of the assembly to which the service limits apply—that is, rather than specifying that merely the disc is life limited, rather the overall rotating assembly, including the disc 20, the blades 22 and associated mounting hardware 24, are designated as the “critical” part to which the life limits in the ICA apply.

Doing so has several implications which result in better safety for civil-certified aeronautical gas turbine engines. Firstly, once the life limit is reached, the entire disc assembly must be replaced as a whole, ensuring that the engine is thus provided with a new assembly which meets the originally-intended design requirements, and thus the specified life limits will safely apply. Secondly, if someone other than the Type Certificate holder designs a new component or component repair for use with the disc assembly, in order to obtain FAA approval for that component (whether through FAA Parts Manufacturer Approval (PMA) or through an FAA Designated Engineering Representative (DER) approval), that person must now demonstrate that the disc assembly, with the new or repaired component, is comparable to the original OEM disc assembly. This has the beneficial effect of helping to ensure that the critical rotating components have services lives which are accurately represented by the limits found in the ICAs, and that actions such as component replacement or repair which could otherwise negatively affect service life, are adequately accounted for prior to regulatory approval being granted for such component replacement or repair.

In the present example, the blades 22, the mounting hardware 24 and other components of the rotating assembly are identified as engine parts having an impact of the service life of the disc 20. As shown in FIG. 1, the disc 20 and associated influencing parts (i.e. the blades 22, the hardware 24 . . . ) are assigned a single assembly part number (P/N) 26. The assembly P/N 26 is then defined as the “critical” part and assigned an LCF life. In use, cycles on the critical assembly P/N 26 are counted. Once the LCF limit is reached, the rotating assembly P/N 26 must be removed from the engine. While the disc must be replaced, the existing blades and hardware may be re-used, if suitable to do so. Repair or replacement to sub-components (e.g. blades, blade retainers, etc.) of the assembly must be substantiated relative to the assembly P/N 26, rather than merely to the corresponding sub-component previously present on in the assembly.

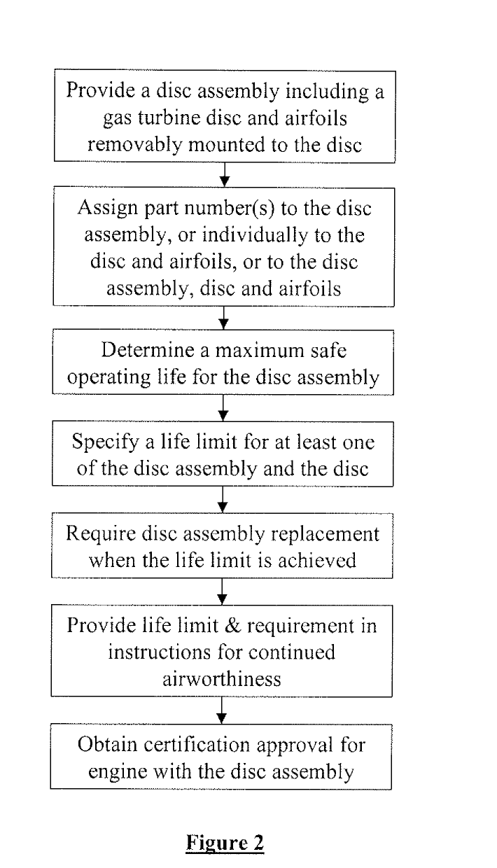

As shown in FIG. 2, life limit values are preferably provided in the airworthiness limitations section of the ICA. Preferably, additional cautions are also provided to the operators and maintenance personnel, such as by including a notice that the given life limit value is only valid for the disc 20 when operated as a component of the rotating assembly designated by P/N 26. In this example, a detail part number is attributed to the disc 20 in addition to the P/N attributed to the rotating assembly. Alternatively, no detail part number may be attributed to the disc 20, and the critical part is instead designated only by the rotating assembly part number 26. Either way, the operator and maintenance personnel are expressly made aware of the fact that changes to individual components of the assembly may affect the service life of the assembly. The operator/maintenance personnel can then take action accordingly.

In both instances (i.e. part number only to the assembly or part number to the disc and the disc assembly), the life limit value is linked to the disc 20 being used as a part of the rotating assembly defined by P/N 26. The life limits are thus logically linked to the parts in service. If an individual component of the rotating assembly 26, such as a blade, is replaced or repaired, other than under the supervision of the Type Certificate holder, then the life limit value no longer applies, according to the above set forth directives, and new life limits for the assembly will need to be determined and substantiated. Consequently, the impact of change on the life limits to critical rotating parts is not overlooked, and a safer assembly results.

The rotating assembly P/N 26 is shown as a procurable P/N in the parts catalogue published by the original engine manufacturer (OEM). Cycles on the critical assembly P/N 26 are counted. More particularly, the rotating assembly LCF life is determined by the number of cycles on the disc 20. Once the LCF limit is reached, the rotating assembly P/N 26 must be removed from the engine. A specialized shop may disassemble it. The disc 20, which is the part of the assembly subject to LCF, must be scrapped. However, the blades 24 may be inspected against defined criteria by the approved specialized repair shop and re-installed in a new disc.

The present process therefore recognizes the importance of repair procedures and component characteristics on the life limits of critical rotating components such as compressor/turbine discs, provides means for ensuring either that the assembly stays within original design requirements of the Type Certificate holder, or alternatively life limits are calculated and substantiated for modified assemblies, all of which results in higher levels of integrity and safety for the rotating assembly. The present approach thus helps ensure that the engine critical rotating parts maintain attributes consistent with those assumed at certification, while ensuring that modification or repair that could impact the integrity of a critical part in a hazardous manner also takes into account effect on assembly service life during airworthiness approval for such modification or repair.

The above description is meant to be exemplary only, and one skilled in the art will recognize that changes may be made to the embodiments described without departing from the scope of the invention disclosed. For example, the same principles could be applied to other critical parts, such as the compressor and the turbofan fan disc and blade assemblies, shafts, and so on. Also, it is understood that the life of a critical part of a rotating assembly may in some circumstances be influenced by an engine part other than a component of the rotating assembly. In this application, the term “aircraft engine” applies to turbofan, turboprop, turboshaft and auxiliary power unit (APU) engines. Still other modifications which fall within the scope of the present invention will be apparent to those skilled in the art, in light of a review of this disclosure, and such modifications are intended to fall within the appended claims.

What is claimed is:

1. A method for maintaining a civil-certified aircraft engine rotating part subject to fatigue failure during service use, the method comprising the steps of:
providing an assembly including the rotating part and at least one other component mounted to the rotating part;
determining a maximum safe operating life for the assembly; and
specifying a life limit for the assembly based on the maximum safe operating life, the life limit being the maximum number of cycles the assembly may be used before replacement.

2. The method defined in claim 1 further comprising the step of certifying the engine, wherein the engine includes the assembly specified as a single part number.

3. The method defined in claim 1, wherein the rotating part is a disc and the at least one component includes a plurality of airfoil blades mounted to the disc, the disc and blades providing the assembly.

4. The method defined in claim 1, wherein the step of specifying a life limit for the assembly comprises specifying a life limit for the part and specifying that said life limit is applicable only when the part is operated with the at least one component as the assembly.

5. The method defined in claim 1, wherein the step of specifying a life limit for the assembly comprises providing directives and limits in instructions for continued airworthiness for the engine.

6. The method defined in claim 1, comprising attributing a procurable part number only to the assembly in a parts catalogue of the engine.

7. The method defined in claim 3, wherein the at least one component further comprises mounting hardware for removably fixing the blades to the disc.

8. The method defined in claim 3, wherein the disc is one of a fan disc, a compressor disc and a turbine disc.

9. A method for providing a service programme for a life-limited part of a gas turbine engine for a civil-certified aircraft, the method comprising: identifying additional components mounted to and impacting a service life of the part, the part and additional components providing an assembly; determining a safe life limit for the assembly; requiring that the entire assembly be replaced when the life limit of the assembly is reached.

10. The method defined in claim 9, wherein the part is a disc and the additional components include airfoil blades mounted to the disc.

11. The method defined in claim 10, wherein the additional components further comprise mounting hardware for removably fixing the blades to the disc.

12. The method defined in claim 10, wherein the disc is one of a fan disc, a compressor disc and a turbine disc.

13. The method defined in claim 9, wherein the method further comprises assigning a single part number to the assembly and specifying the life limit is applicable to the part number.

14. The method defined in claim 9, comprising attributing a procurable part number only to the assembly in a parts catalogue of the engine.

15. The method defined in claim 9, further comprising identifying the life limit in instructions for continued airworthiness for the engine.

16. The method defined in claim 9, wherein the step of determining a safe life limit for the assembly comprises specifying a life limit for the part and specifying that said life limit is applicable only when the part is operated with the additional component as the assembly.

17. A method for safely managing the replacement/servicing of a part of a rotating assembly of an aircraft gas turbine engine, the rotating assembly comprising a disc, a plurality of blades, and attachment hardware for removably fixing the blades to the disc, the method comprising: designating at least the disc and blades as a critical assembly, specifying a life limit for the assembly, and requiring replacement of the entire assembly when the life limit is achieved.

18. The method of claim 17, wherein the assembly is assigned a single part number.

19. The method of claim 17, further comprising obtaining certification from an airworthiness authority for an aircraft engine including the assembly.

20. The method of claim 17, wherein the life limit for the assembly corresponds to the service life of the disc.
